(19) United States
(12) Patent Application Publication
(10) Pub. No.: US 2013/0025186 A1
(43) Pub. Date: Jan. 31, 2013

(54) Insect Extermination Device

(71) Applicants: Markus Scheubeck, Regensburg (DE); Thomas Scheubeck, Regensburg (DE); Irmgard Scheubeck, Regensburg (DE)

(72) Inventors: Markus Scheubeck, Regensburg (DE); Thomas Scheubeck, Regensburg (DE); Irmgard Scheubeck, Regensburg (DE)

(21) Appl. No.: 13/361,603

(22) Filed: Jan. 30, 2012

Related U.S. Application Data
(63) Continuation of application No. PCT/EP2010/058076, filed on Jun. 9, 2010.

(30) Foreign Application Priority Data
Jun. 10, 2009 (DE) DE 102009026896.0

(51) Int. Cl. A01M 3/02

(52) U.S. Cl. 43/137

(57) ABSTRACT

An insect extermination device through which insects are killed in a simple and effective manner by slowly advancing the device toward the insects and striking the insects. An impact element is advantageously made from a highly transparent, smooth foil, which is advantageously connected to a handle rod through a coupling element and a link and is replaceable.

### RELATED APPLICATIONS

This application is a continuation of International application PCT/EP2010/058076 filed on Jun. 9, 2010 claiming priority from German application DE 10 2009 026 896.0 filed on Jun. 10, 2009, both of which are incorporated in their entirety by this reference.

### FIELD OF THE INVENTION

The invention relates to an insect extermination device.

### BACKGROUND OF THE INVENTION

Various means can be used for insect extermination but all have their disadvantages.

Chemical insect extermination agents are very effective but the application is difficult expensive and associated with health risks,

Electrical insect extermination devices naturally require an electrical connection that is not available everywhere, and they are relatively large and expensive to acquire and maintain.

Furthermore static insect extermination devices are known like spirals coated with adhesives, however, after some time they become unappealing for esthetic and hygienic reasons due to the adhering insect corpses.

Prior art transparent adhesive foils which are provided with attractants which can be glued into corners of windows have a disadvantage in being stationary similar to the recited glue spirals, and at least after longer use can appear unattractive and appalling to some people in particular when eating directly next to them.

So called fly swatters which include a handle and a flexible punctured plastic blade attached to the handle are relatively simple devices. Typically they are made completely from a colored plastic material. When using these devices, however, the insects are typically already caused to escape through the created air flow and the shadow of the impact element. In some cases they cannot be used at all since they are not suitable for some spacial situations (corners, high walls, and ceilings of rooms). When the insects are sitting on people they cannot be used either since they might cause pain. Unattractive stains at walls or pieces of furniture are often caused by this type of insect extermination.

### BRIEF SUMMARY OF THE INVENTION

Thus it is an object of the invention to provide an insect extermination device which overcomes the disadvantages of the prior art, which is very efficient in a variety of applications, easy to handle and clean and cost effective to manufacture.

The problem is solved through the inventive features of in an unexpectedly simple manner, wherein the impact element configured as a base plate is configured highly transparent. These inventive features include an impact element configured as a base plate including at least one edge, and a rod shaped handle arranged at the at least one edge, where the impact element is highly transparent.

This greatly increases the operational success of the device. Configuring the base plate from a highly transparent material, advantageously from a highly transparent foil facilitates approaching the insect in a slow and controlled manner since the insect neither senses a shadow nor a visible object. Thus, it is possible to exterminate the insect through a controlled low impact blow.

Through the high transparency of the impact element the insect is not warned any more through an appearing shadow and the advantageous slow approach to the insect prevents a warning air draft. The insect can be eliminated now through a slight impact and the formation of stains is significantly reduced or totally avoided. Furthermore targeting the insect by a person is highly simplified since a continuous visual contact is provided due to the transparency of the material. Through the high flexibility of the foil the formation of stains at walls or objects is minimized even for a strong impact.

The advantageous slow approach to the insect is not required but has the advantage that the insect is eliminated by a slight blow so that even when exterminating insects sitting on people no painful injuries are caused.

The rod shaped handle can be connected to the base plate or integrally configured therewith in one piece depending on the manufacturing process that is being used.

The rod shaped handle is advantageously connected to the base plate in a disengageable manner. Thus, the device can be quickly disassembled in its components and fits, for example, into at travel bag or a suitcase. Furthermore the impact element can be easily replaced which saves resources and is environmentally friendly.

It is particularly advantageous when the coupling piece is configured as a link which is adjustable or interlockable at various angles. This has the effect that the device can now also be used in situations in which it would have previously failed due to its rigidity. Now there is no problem anymore to kill an insect which sits on a vertical wall or a ceiling at a rather high elevation since only the angle has to be adapted accordingly.

However, also embodiments are feasible in which the coupling element is rigidly connected with the rod shaped angle, wherein the coupling element is oriented straight, thus in a direction of 180° or can extend at a defined angle.

It is furthermore advantageous when the base plate has at least one corner, preferably a rectangular corner. Embodiments are also advantageous in particular in which the base plate is rectangular, in particular square. These embodiments have a significant advantage in that the device can reach any corner of a room.

When the rod shaped handle is configured extensible another advantageous embodiment is provided. Now it is no longer a problem to exterminate insects which sit on the high ceilings of old buildings. The handle can be extended in a telescoping manner or can be extended through extension pieces.

In order to always maintain the device in an optically appealing and hygienically proper condition it is advantageous to configure it from a rinse able, or even dish cleaner proof material.

It is advantageous to provide plural impact elements with various sizes, and/or shapes and/or materials that are interchangeable. Thus, impact elements can be alternatively used that are optimized for various applications.

Another advantageous embodiment of the insect extermination device according to the invention includes providing the impact element with at least one small bent over edge or with at least one spacer. For example particular knob shaped spacers can be provided in corner portions or in the corners of the impact element which provides that an insect is not completely crushed even under a hard blow since an intermediary space that corresponds to the height of the spacer always remains between the impact element and an object like, for example, a wall. This in turn has the advantage that the formation of stains at walls or objects is minimized.

When the impact element is produced from bubble foil the spacers can already be integrally formed while producing the impact element.

Depending on the size of the insects to be exterminated it can be helpful to be able to vary the height of the spacers.

In another embodiment a particular precisely fitting foil can be attached at the bent over edges, wherein the foil is provided with glue on one side. For example the spacers can have the shape of a cut off cone onto which the glue foil is placed with respective holes so that the surface of the glue foil that is not provided with glue contacts the impact element without a distance there between or with a small distance there between and is supported through form locking between the spacers and the edges of the hole. The surface of the glue foil that is provided with glue is thus arranged below the plane formed by the top sides of the spacers so that the insect extermination device can still be used as a fly swatter without the glue of the glue foil reaching the walls or other objects. Thus, it is advantageous again that the smashed insects immediately adhere to the glue foil and a subsequent collecting of the insect cadavers is not required.

Alternatively the glue foil can also be at least configured as a double sided glue foil so that it can be glued flat onto the surface of the impact element. It is also conceivable to apply the glue foil to the impact element through adhesive strips or similar. In order to facilitate easy pull off or exchange of the glue foil it is useful when the gluing surfaces through which the glue foil is attached to the impact element are kept as small as possible. The spacers in this case only perform their spacer function and are used at the most as a positioning aid for the glue foil.

When the glue foil is provided with attractants this has another advantage. Besides using the insect extermination device in mobile operations it can also be used as a stationary insect extermination device. In particular when the device has a separate or integral base it can be optionally placed at any location where it operates similar to the known spirals. However, the device according to the invention also facilitates actively hunting disturbing insects anytime.

Other advantageous embodiments of the invention can be derived from the following feature taken individually or in any combination:
The impact element is made from a flexible foil;
The impact element is connected with the rod shaped handle through a straight rigid coupling element that is aligned in 180° direction;
The impact element is connected with the rod shaped handle through a rigid coupling element at a defined angle;
The impact element is connected through a coupling element with the rod shaped handle, and the coupling element is configured as a link which is adjustable or interlockable at different angles;
The rod shaped handle is formed at the impact element;
The rod shaped handle is integrally configured with the impact element in one piece;
The rod shaped handle is removably attached at the impact element so that the impact element is replaceable;
The rod shaped handle, the coupling element, the link and the impact element are highly transparent;
The impact element includes at least one corner;
The impact element includes at least one rectangular corner;
The impact element is rectangular, square or polygonal;
The rod shaped handle is extensible;
The rod shaped handle is extensible through extension pieces;
The rod shaped handle is an extensible telescope;
The insect extermination device is configured from a rinseable washable or dish washer proof material;
The insect extermination device includes plural exchangeable impact elements with various sizes and/or shapes and/or materials;
The impact element includes at least one spacer and/or at least one bent edge, and the spacer and/or the bent edge are preferably height adjustable;
The at least one spacer or the at least one bent edge is configured so that a transparent self adhesive foil can be attached thereto;
The transparent self adhesive foil is at least partially glued on a surface of the impact element;
The transparent self adhesive foil is provided with attractants;
The insect extermination device includes an integrally formed stand at an end of the handle, and the end of the handle faces away from the impact element; and
The insect extermination device includes a separate stand into which an end of the handle that faces away from the impact element and is insertable and removeable.

### BRIEF DESCRIPTION OF THE DRAWINGS

The invention is subsequently described based on an advantageous embodiment and with reference to the appended drawing figures, wherein:

FIG. 1 illustrates a perspective view of an advantageous embodiment of the insect extermination device;

FIG. 2 illustrates the impact element of the device including the link of FIG. 1 in an enlarged perspective view;

FIG. 3 illustrates the impact element of the device according to FIG. 1 in a top view;

FIG. 4 illustrates the impact element of to the device of FIG. 1 in another side view;

FIG. 5 illustrates another embodiment of an impact element with spacers in a perspective view;

FIG. 6 illustrates the impact element of FIG. 5 in top view;

FIG. 7 illustrates a transparent glue foil in top view;

FIG. 8 illustrates the base plate of FIG. 5 in another lateral view; and

FIG. 9 illustrates the device of FIG. 5 in a stand.

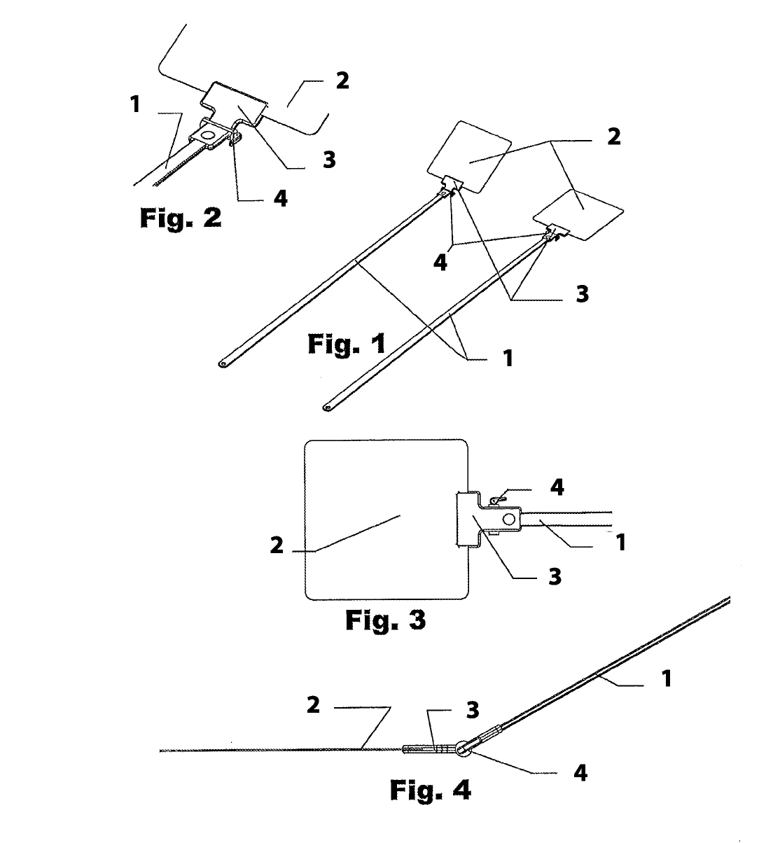

### DETAILED DESCRIPTION OF THE INVENTION

FIG. 1 illustrates an insect extermination device with a handle 1 in an exemplary embodiment in which an impact element 2 which is configured as a plate shaped base plate is made from a rectangular highly transparent foil which is connected through a coupling component 3 with a link 4 with the handle 1.

The link 4 is configured so that it can be adjusted to different angular conditions by applying a small amount of force. This can be provided in interlocking steps or continuously variable through a clamping effect as illustrated herein.

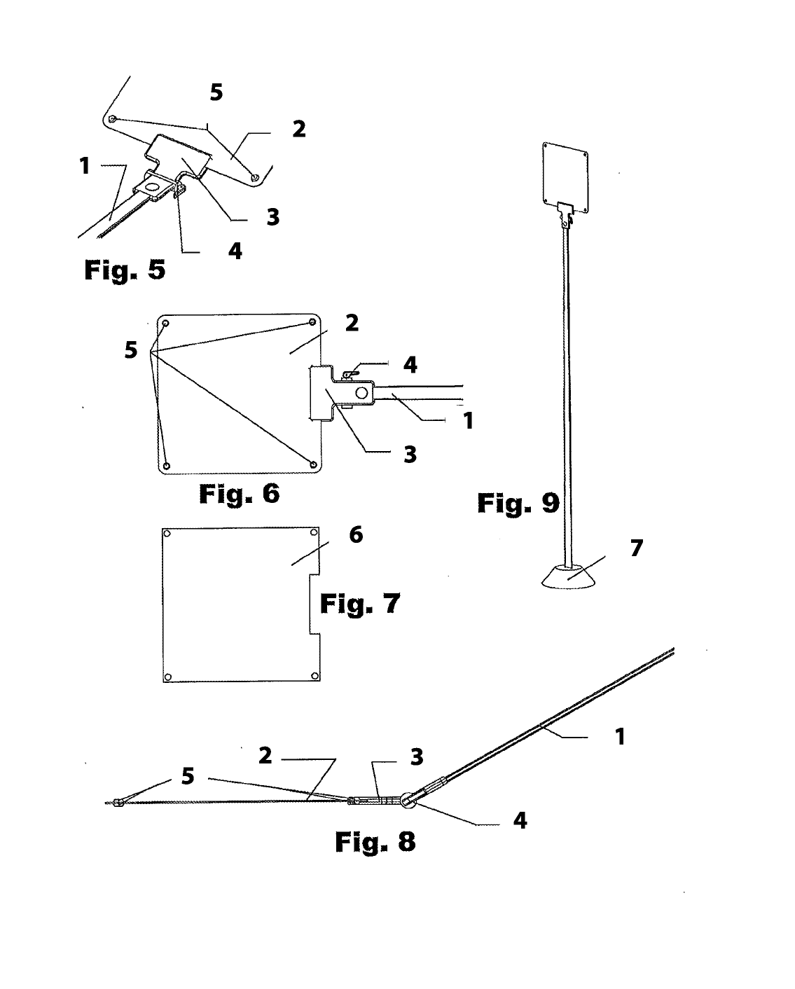

FIGS. 5 and 6 illustrate an insect extermination device whose impact element 2 is provided with four spacers 5 which are respectively arranged in a corner portion of the impact element 2. It is apparent from FIG. 8 that the spacers 5 are frustum shaped, wherein the impact element 2 is provided on both sides with spacers 5. However, the spacers can also have any other shape.

FIG. 7 illustrates a transparent glue foil 6 which is only provided with glue on one of its surfaces. The glue foil 6 has holes in its corners which correspond to the spacers 5, wherein the glue foil 6 can be attached to the impact element 2 through the holes. In FIG. 8 the mounted glue foil is proximal to the impact element 2 so that it is not visible in FIG. 8.

Eventually FIG. 9 illustrates the insect extermination device of FIG. 5 which is mounted in a stand 7 with its handle rod 1. Alternatively the stand 7 can also be integrally configured with the handle rod 1 in one piece.

### REFERENCE NUMERALS AND DESIGNATIONS

handle rod

impact element

coupling piece

link

spacer

transparent glue foil

stand

What is claimed is:

1. An insect extermination device comprising:
an impact element configured as a base plate including at least one edge; and
a rod shaped handle arranged at the at least one edge,
wherein the impact element is highly transparent.

2. The insect extermination device according to claim 1, wherein the impact element is made from a flexible foil.

3. The insect extermination device according to claim 1, wherein the impact element is connected with the rod shaped handle through a straight rigid coupling element that is aligned in 180° direction.

4. The insect extermination device according to claim 1, wherein the impact element is connected with the rod shaped handle through a rigid coupling element at a defined angle.

5. The insect extermination device according to claim 1,
wherein the impact element is connected through a coupling element with the rod shaped handle, and
wherein the coupling element is configured as a link which is adjustable or interlockable at different angles.

6. The insect extermination device according to claim 1, wherein the rod shaped handle is formed at the impact element.

7. The insect extermination device according claim 1, wherein the rod shaped handle is integrally configured with the impact element in one piece.

8. The insect extermination device according to claim 1, wherein the rod shaped handle is removably attached at the impact element so that the impact element is replaceable.

9. The insect extermination device according to claim 1, wherein the rod shaped handle, the coupling element, the link and the impact element are highly transparent.

10. The insect extermination device according to claim 1, wherein the impact element includes at least one corner.

11. The insect extermination device according to the claim 10, wherein the impact element includes at least one rectangular corner.

12. The insect extermination device according to claim 10, wherein the impact element is rectangular.

13. The insect extermination device according to claim 10, wherein the impact element is square.

14. The insect extermination device according to claim 10, wherein the impact element is polygonal.

15. The insect extermination device according to claim 1, wherein the rod shaped handle is extensible.

16. The insect extermination device according to claim 12, wherein the rod shaped handle is extensible through extension pieces.

17. The insect extermination device according to claim 12, wherein the rod shaped handle is an extensible telescope.

18. The insect extermination device according to claim 1, wherein the insect extermination device is configured from a rinseable washable or dish washer proof material.

19. The insect extermination device according to claim 1, wherein the insect extermination device includes plural exchangeable impact elements with various sizes or shapes or materials.

20. The insect extermination device according to claim 1,
wherein the impact element includes at least one spacer or at least one bent edge, and
wherein the spacer or the bent edge are height adjustable.

21. The insect extermination device according to claim 20, wherein the at least one spacer or the at least one bent edge is configured so that a transparent self adhesive foil can be attached thereto.

22. The insect extermination device according to claim 21, wherein the transparent self adhesive foil is at least partially glued on a surface of the impact element.

23. The insect extermination device according to claim 21, wherein the transparent self adhesive foil is provided with attractants.

24. The insect extermination device according to claim 1,
wherein the insect extermination device includes an integrally formed stand at an end of the handle, and
wherein the end of the handle faces away from the impact element.

25. The insect extermination device according to claim 1, wherein the insect extermination device includes a separate stand into which an end of the handle that faces away from the impact element and is insertable and removeable.
